(19) United States
(12) Patent Application Publication
(10) Pub. No.: US 2018/0268820 A1
(43) Pub. Date: Sep. 20, 2018

(54) METHOD AND SYSTEM FOR GENERATING CONTENT USING SPEECH COMMENT

(71) Applicant: NAVER Corporation, Seongnam-si (KR)

(72) Inventors: Chan Kyu PARK, Seongnam-si (KR); Jung Sik KIM, Seongnam-si (KR); Jun-ho HWANG, Seongnam-si (KR); Sujin MIN, Seongnam-si (KR); Dae Hwang KIM, Seongnam-si (KR)

(73) Assignee: NAVER Corporation, Seongnam-si (KR)

(21) Appl. No.: 15/922,045

(22) Filed: Mar. 15, 2018

(30) Foreign Application Priority Data
Mar. 16, 2017 (KR) 10-2017-0032965

(51) Int. Cl. G10L 15/26; G06F 17/24; G10L 15/00; G06Q 50/00

(52) U.S. Cl. CPC G10L 15/265; G06Q 50/01; G10L 15/005; G06F 17/241

(57) ABSTRACT

Disclosed is a method and system for creating content using a speech comment. A content providing method configured as a computer may include creating content in which an audio file and a text extracted from speech of a user are combined, the speech being recorded as a comment on a posting, and providing the content as a speech comment of the user.

### CROSS-REFERENCE TO RELATED APPLICATION(S)

This application claims priority under 35 U.S.C. § 119 to Korean Patent Application No. 10-2017-0032965 filed on Mar. 16, 2017, in the Korean Intellectual Property Office (KIPO), the entire contents of which are incorporated herein by reference.

### BACKGROUND

### Field

One or more example embodiments relate to techniques for creating and distributing content.

### Description of Related Art

In the recent times, due to a wide-spread use of a personalized information processing device and high-speed wired/wireless communication networks, sharing information and data online has become very popular.

Conventionally, a comment registration interface capable of attaching various comments of users has been provided to many of postings published on the Internet. Such interfaces allow users to post comments (e.g., opinions) on posted matters.

For example, a technique for receiving comment information associated with a specific area of a page and outputting the comment information on a designated area adjacent to the specific area of the page is disclosed in Korean Laid-Open Publication No. 10-2017-0016164, published on Feb. 13, 2017.

With a recent significant increase in a data transmission rate (e.g., data bandwidth) of a wired/wireless communication network, sharing of information using speech, instead of simply sharing text-based information between users, becomes popular.

### SUMMARY

One or more example embodiments provide methods and/or systems that create and distribute content in a form of a speech comment.

One or more example embodiments provide a methods and/or systems that create and distribute a single piece of content in which speech and text are combined.

One or more example embodiments provide methods and/or systems that automatically inspect and distribute content in a form of a speech comment.

One or more example embodiments provide methods and/or systems that select a recognition target language during a process of providing speech recognition.

One or more example embodiments provide methods and/or systems that use content created using a speech comment in various types of service platforms.

One or more example embodiments provide methods and/or systems that apply various speech filters or synthesis techniques to content in a form of a speech comment.

According to an example embodiment, a content providing method configured as a computer includes creating content in which an audio file and text extracted from speech of a user are combined, the speech being recorded as a comment on a posting, and providing the content as a speech comment of the user.

The method may further include recording the speech of the user by recording a speech signal input through speech recognition as the audio file in real time, and concurrently extracting a text from the speech signal through the speech recognition in real time.

The creating may include applying at least one of a speech filter or a speech synthesis technique to the audio file at a creation point in time of the content.

The providing may include applying at least one of a speech filter or a speech synthesis technique to the audio file at a providing point in time of the content.

The method may further include recording the speech by recording a speech signal input through speech recognition as the audio file in real time, setting a recognition target language based on language information associated with the user of the speech, and performing the speech recognition based on the set recognition target language.

The setting a recognition target language may include at least one of (i) automatically setting the recognition target language based on the language information included in profile information of the user or language information corresponding to a location of the user, or (ii) setting as a language selected by the user.

The method may further include correcting the text before providing the content as the speech comment, and managing an original version and a corrected version of the text in response to the correcting.

The method may further include performing an automated inspection on the content using the text before providing the content as the speech comment.

The providing may include providing one or more contents as one or more speech comments in a comment list of the posting by displaying the text included in each of the one or more speech comments, the one or more contents including the content, the one or more speech comments including the speech comment, and playing an audio file associated with the displayed text in response to an input through a user interface.

The providing may include at least one of providing a first interface for individually playing an audio file associated with a corresponding one from among the one or more speech contents included in the comment list and providing a second interface for collectively playing audio files associated with an entirety of the one or more speech contents included in the comment list.

According to an example embodiment, a non-transitory computer-readable recording medium storing instructions that, when executed by a processor, cause the processor to perform a content providing method including creating content in which an audio file and text extracted from speech of a user are combined, the speech being recorded as a comment on a posting, and providing the content as a speech comment of the user.

According an example embodiment, a system configured as a computer includes at least one processor configured to execute computer-readable instructions. The at least one processor is configured to create content in which an audio file and text extracted from speech of a user are combined, the speech being recorded as a comment on a posting, and provide the content d as a speech comment of the user.

According to some example embodiments, it is possible to enhance the user convenience and the utilization of speech content by creating and distributing content of a new type that is a speech comment.

According to some example embodiments, it is possible to overcome limits and issues found in the art that creates and distributes content in a speech form and content in a text form as individual contents by creating and distributing a form in which speech and text are combined as a single piece of content.

According to some example embodiments, it is possible to apply an automated inspection system and to perform an automated inspection by creating content in a form in which speech and text are combined and by distributing a text corresponding to speech content.

According to some example embodiments, it is possible to enhance the user convenience and to increase an accuracy of a speech recognition rate by selecting a recognition target language during speech recognition providing process.

According to some example embodiments, it is possible to use an actual speech of a user as new content in various forms in various types of service platforms by creating and distributing content in a form in which speech and text are combined.

According to some example embodiments, it is possible to create distinctive and entertaining content and to protect an actual speech of a user as personal information by applying various speech filters or synthesis techniques to content in a form of a speech comment.

Further, areas of applicability will become apparent from the description provided herein. The description and specific examples in this summary are intended for purposes of illustration only and are not intended to limit the scope of the present disclosure.

### BRIEF DESCRIPTION OF THE FIGURES

Example embodiments will be described in more detail with reference to the figures, wherein like reference numerals refer to like parts throughout the various figures unless otherwise specified, and wherein:

FIG. 1 is a diagram illustrating an example of a network environment according to at least one example embodiment;

FIG. 2 is a block diagram illustrating an example of a configuration of an electronic device and a server according to at least one example embodiment;

FIG. 3 is a block diagram illustrating an example of components includable in a processor of a server according to at least one example embodiment;

FIG. 4 is a flowchart illustrating a method performed by a server according to at least one example embodiment; and

FIGS. 5 through 10 illustrate examples of a user interface screen associated with creation and distribution of speech comment content according to some example embodiments.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given example embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated example embodiments. Rather, the illustrated example embodiments are provided as examples so that this disclosure will be thorough and complete, and will fully convey the concepts of this disclosure to those skilled in the art. Accordingly, known processes, elements, and techniques, may not be described with respect to the disclosed example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, or a microprocessor), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. For example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data). The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device. However, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of the example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

The example embodiments relate to a technique for creating new content using a speech comment.

The example embodiments disclosed herein may create and distribute content combining speech and text as a single comment on a posting, thereby achieving many advantages, such as utilization, convenience, accuracy, security, efficiency, cost reduction, etc.

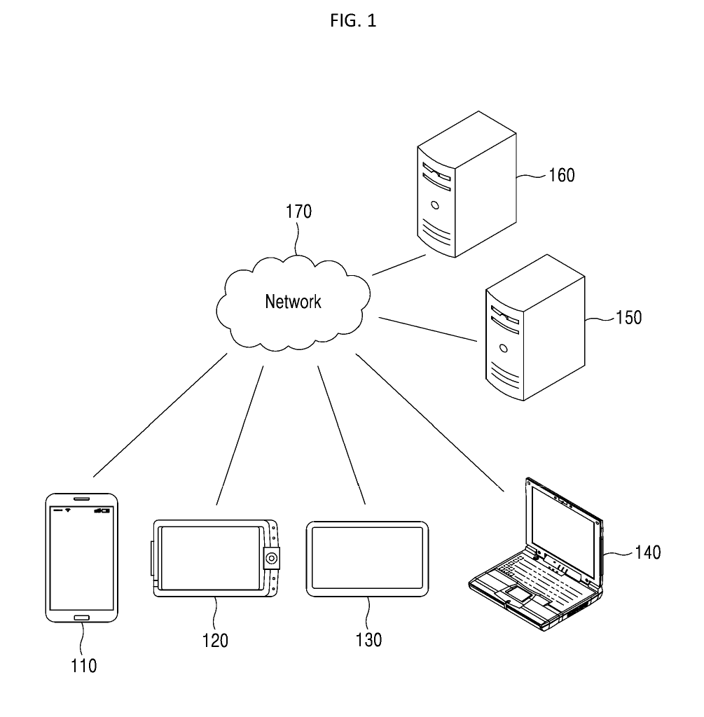

FIG. 1 is a diagram illustrating an example of a network environment according to at least one example embodiment. Referring to FIG. 1, the network environment includes a plurality of electronic devices 110, 120, 130, and 140, a plurality of servers 150 and 160, and a network 170. FIG. 1 is provided as an example only. The number of electronic devices and/or a number of servers are not limited thereto.

Each of the plurality of electronic devices 110, 120, 130, and 140 may be a fixed terminal or a mobile terminal configured as a computer device. For example, the plurality of electronic devices 110, 120, 130, and 140 may be a smartphone, a mobile phone, a tablet personal computer (PC), a navigation, a computer, a laptop computer, a digital broadcasting terminal, a personal digital assistant (PDA), a portable multimedia player (PMP), etc. For example, the electronic device 110 may communicate with other electronic devices 120, 130, and/or 140, and/or the servers 150 and/or 160 over the network 170 in a wired communication manner or in a wireless communication manner.

The communication scheme is not particularly limited and may include a communication method that uses a near field communication between devices as well as a communication method using a communication network, for example, a mobile communication network, the wired Internet, the wireless Internet, a broadcasting network, a satellite network, etc., which may be included in the network 170. For example, the network 170 may include at least one of network topologies that include, for example, a personal area network (PAN), a local area network (LAN), a campus area network (CAN), a metropolitan area network (MAN), a wide area network (WAN), a broadband network (BBN), and the Internet. Further, the network 170 may include at least one of network topologies that include, for example, a bus network, a star network, a ring network, a mesh network, a star-bus network, and/or a tree or hierarchical network. However, it is only an example and the example embodiments are not limited thereto.

Each of the servers 150 and 160 may be configured as a computer apparatus or a plurality of computer apparatuses that provide, for example, instructions, codes, files, contents, and/or services through communication with the plurality of electronic devices 110, 120, 130, and/or 140 over the network 170.

For example, the server 160 may provide a file for installing an application to the electronic device 110 connected through the network 170. In this case, the electronic device 110 may install the application using the file provided from the server 160. Also, the electronic device 110 may access the server 150 under control of at least one program, for example, browser or the installed application, or an operating system (OS) included in the electronic device 110, and may use a service or content provided from the server 150. For example, when the electronic device 110 transmits a service request message to the server 150 through the network 170 under control of the application, the server 150 may transmit a code corresponding to the service request message to the electronic device 110 and the electronic device 110 may provide content to a user by configuring and displaying a screen according to the code under control of the application.

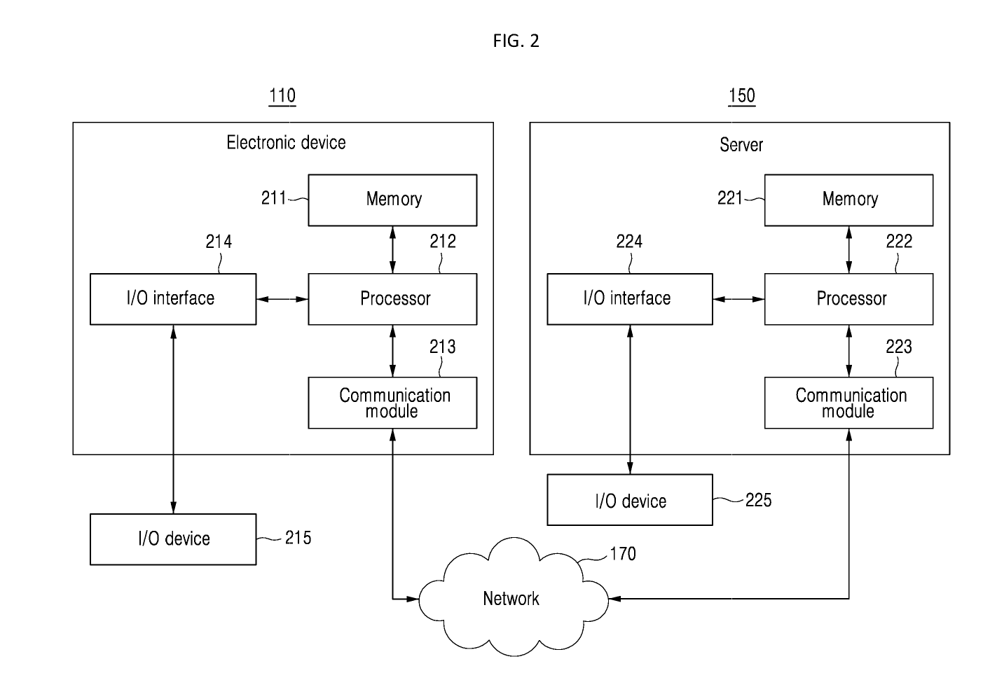

FIG. 2 is a block diagram illustrating an example of a configuration of an electronic device and a server according to at least one example embodiment. FIG. 2 illustrates a configuration of the electronic device 110 as an example for a single electronic device and illustrates a configuration of the server 150 as an example for a single server. The same or similar components may be applicable to other electronic devices 120, 130, and/or 140, or the server 160, and also to still other electronic devices or still other servers.

Referring to FIG. 2, the electronic device 110 may include a memory 211, a processor 212, a communication module 213, and an input/output (I/O) interface 214, and the server 150 may include a memory 221, a processor 222, a communication module 223, and an I/O interface 224. The memory 211, 221 may include a permanent mass storage device such as random access memory (RAM), read only memory (ROM), a disk drive, a solid state drive, a flash memory, etc. as a non-transitory computer-readable storage medium. An OS or at least one program code, for example, a code for an exclusive application or a browser installed and executed on the electronic device 110, may be stored in the memory 211, 221. Such software components may be loaded from another non-transitory computer-readable storage medium separate from the memory 211, 221 using a drive mechanism. The other non-transitory computer-readable storage medium may include, for example, a floppy drive, a disk, a tape, a DVD/CD-ROM drive, or a memory card. According to other example embodiments, software components may be loaded to the memory 211, 221 through the communication module 213, 223, instead of, or in addition to, the non-transitory computer-readable storage medium. For example, at least one program may be loaded to the memory 211, 221 based on a program (e.g., the application) installed by files provided over the network 170 from developers or a file distribution system (e.g., the server 160), which provides an installation file of the application.

The processor 212, 222 may be configured to process computer-readable instructions (e.g., the aforementioned at least one program code) of a computer program by performing basic arithmetic operations, logic operations, and/or I/O operations. The computer-readable instructions may be provided from the memory 211, 221 and/or the communication module 213, 223 to the processor 212, 222. For example, the processor 212, 222 may be configured to execute received instructions in response to the program code stored and read from in the storage device such as the memory 211, 222.

The communication module 213, 223 may provide a function for communication between the electronic device 110 and the server 150 over the network 170, and may provide a function for communication between the electronic device 110 and/or the server 150 and another electronic device, for example, the electronic device 120 or another server, for example, the server 160. For example, the processor 212 of the electronic device 110 may transfer a request (e.g., a search request) created based on a program code stored in the storage device such as the memory 211, to the server 150 over the network 170 under control of the communication module 213. Conversely, a control signal, an instruction, content, a file, etc. provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211. In some example embodiments, the electronic device 110 may further include a storage medium for storing content, a file, etc.

The I/O interfaces 214 and 224 may be a device used for interface with I/O devices 215 and 225. For example, an input device may include a keyboard, a mouse, a microphone, a camera, etc., and an output device may include, for example, a display for displaying a communication session of the application. As another example, the I/O interface 214 may be a device for interface with an apparatus in which an input function and an output function are integrated into a single function, such as a touch screen. For example, when processing instructions of the computer program loaded to the memory 211, the processor 212 of the electronic device 110 may display a service screen configured using data provided from the server 150 or the electronic device 110, or may display content on a display through the I/O interface 214.

According to other example embodiments, the electronic device 110 and the server 150 may include a greater or lesser number of components than the components shown in FIG. 2. However, there is no need to clearly illustrate many components well-known in the related art. For example, the electronic device 110 may include at least a portion of the I/O device 215, or may further include other components, for example, a transceiver, a global positioning system (GPS) module, a camera, a variety of sensors, and/or a database. Further, if the electronic device 110 is a smartphone, the electronic device 110 may be configured to further include a variety of components, for example, an accelerometer sensor, a gyro sensor, a camera, various physical buttons, a button using a touch panel, an I/O port, and/or a vibrator for vibration, etc.

Hereinafter, some example embodiments of a method and system that may create and distribute a form in which speech and text are combined as a single piece of content will be described.

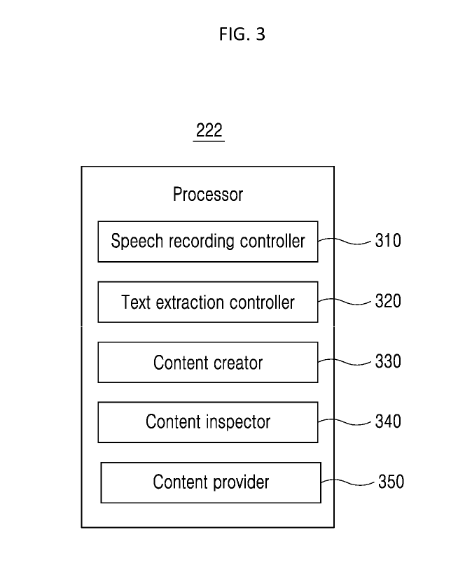

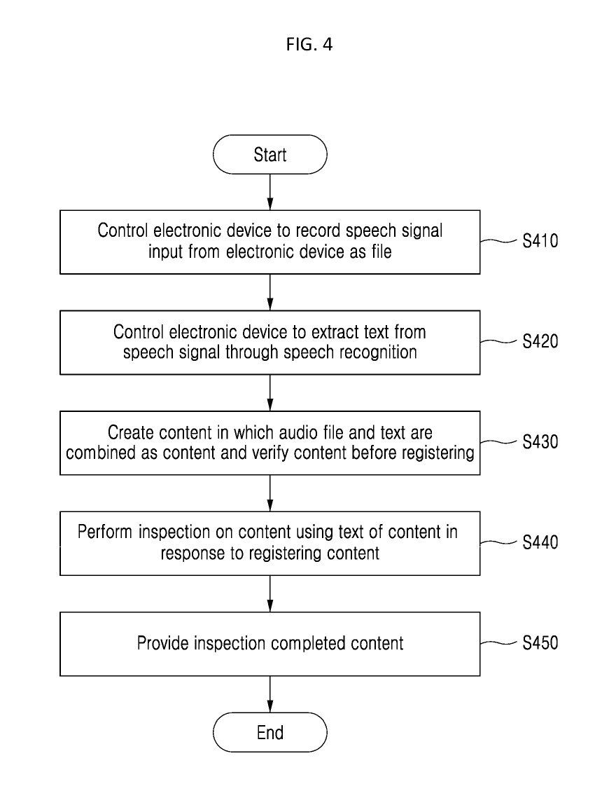

FIG. 3 is a block diagram illustrating an example of components includable in a processor of a server according to at least one example embodiment. FIG. 4 is a flowchart illustrating a method performed by a server according to at least one example embodiment.

The server 150 may serve as a service platform to provide digital contents to the plurality of electronic devices 110, 120, 130, and/or 140 that are clients. Here, the server 150 may provide an environment capable of creating and distributing content of a new type that is a speech comment, and may create and distribute content in which speech and text are combined by providing a speech-to-text (STT) function.

Referring to FIG. 3, the processor 222 of the server 150 may include a speech recording controller 310, a text extraction controller 320, a content creator 330, a content inspector 340, and a content provider 350 as components. The processor 222 (e.g., the components of the processor 222) may control the server 150 to perform operations S410 through S450 included in the method of FIG. 4. Here, the processor 222 and the components of the processor 222 may be configured to execute instructions according to a code of at least one program and a code of an OS included in the memory 221. In some example embodiments, the components of the processor 222 may be representations of different functions performed by the processor 222 in response to a control instruction provided from the OS or the at least one program. For example, the speech recording controller 310 may be used as a functional representation to control the processor 222 to record a recognized speech in response to the control instruction.

The server 150 may provide an environment capable of attaching a comment in various forms with respect to a posting on a service platform. For example, the server 150 may create and distribute a comment on a posting as content of a new type (e.g., content in which speech and text are combined (hereinafter, referred to as speech comment content)). One aspect of the speech comment content is to record an actual speech of a user on the posting and to leave the actual speech as a comment. Another aspect of the speech comment content is to provide a text input convenience of automatically inputting a text, instead of directly typing the text.

Referring to FIG. 4, in operation S410, the speech recording controller 310 may control the electronic device 110 to record a speech signal by recording the speech signal input from the electronic device 110 as a file. A speech comment interface capable of inputting a comment using speech may be provided to a posting. In response to a selection on the speech comment interface, a microphone of the electronic device 110 may be turned ON and speech according to a user utterance may be received through the microphone. Accordingly, in response to receiving the speech signal from a hardware microphone of the electronic device 110, the speech recording controller 310 may control the electronic device 110 to record the corresponding speech signal as a file in real time. The speech recording controller 310 may apply various speech filters or synthesis techniques at a speech recording point in time for creating the speech comment content. For example, the speech recording controller 310 may process speech recording by applying a baby voice, a charming voice, an angry voice, an applauding sound, a cheering sound, a voice of a specific user such as a voice actor, and the like. A speech filter or a synthesis technique to be applied to the speech recording may be selected by the user, or a preset default function may be applied. By applying the speech filter or the synthesis technique at the speech recording point in time, it is possible to create the distinctive and entertaining content, and to protect personal information associated with an actual speech of the user.

In operation S420, the text extraction controller 320 may control the electronic device 110 to extract a text from the speech signal input from the electronic device 110 through a speech recognizer. The speech recognizer may provide an STT function of converting speech to text as a technique of converting speech uttered by the user to text (code) information treatable at a computer. The text extraction controller 320 may extract the text from the speech signal in real time using the speech recognizer for creating the speech comment content. That is, the text extraction controller 320 may automatically create a text by extracting the text from the speech signal through the speech recognition. Here, the text extraction controller 320 may set a recognition target language, for example, Korean, Chinese, Japanese, etc., based on language information associated with the user and may perform speech recognition based on the set language. The recognition target language may be automatically set based on language information included in user profile information, language information corresponding to a location of the electronic device 110, etc., and may be manually set as a language directly set by the user, for example, prior to the speech recognition. By setting the recognition target language during a speech recognition providing process, it is possible to enhance the user convenience and to increase an accuracy of a speech recognition rate.

Herein, to create the speech comment content, a speech recording function may be provided and a function of extracting a text through the speech recognition may be provided together. As a number of characters allowed for a comment is generally limited, the speech recording may be limited to a desired (or alternatively, preset) length of time, for example, 60 seconds. The speech recording and the text extraction may be performed simultaneously in real time. Here, the speech recording may be controlled to match a desired (or alternatively, preset) number of characters for a text. That is, although the speech recording and the text extraction are simultaneously performed, the speech recording may be performed until a number of characters included in the extracted text reaches the desired (or alternatively, preset) number of characters.

An entity that performs the speech recording and the text extraction with respect to speech may be configured on any one of the electronic device 110 and the server 150. The electronic device 110 may record speech and extract text from the speech and may transmit a recorded audio file and the extracted text of the speech to the server 150. In some example embodiments, the electronic device 110 may transfer an input speech signal input to the server 150 in real time, and the server 150 may record the speech signal as a file and may extract a text from the speech.

As an example of a speech transfer scheme between the electronic device 110 and the server 150, the electronic device 110 may record a speech signal input through the microphone as an audio file and may transfer the recorded entire audio file to the server 150. As another example, the electronic device 110 may transfer the entire speech signal input through the microphone to the server 150 in real time, and accordingly the server 150 may record the speech signal transferred from the electronic device 110 as a file (e.g., an audio file). As another example, if the electronic device 110 that is a terminal end performs speech recognition, the electronic device 110 may separate an entire audio file into a speech presence portion in which an actual speech is recorded and a speech absence portion and may transfer the speech presence portion to the server 150.

In operation S430, the content creator 330 may create content in which the audio file recorded in operation S410 and the text extracted in operation S420 are combined as the speech comment content according to the speech recognition. The content creator 330 may combine the audio file and the text to provide a single piece of content (e.g., speech comment content) to create and use the speech and the text together. Accordingly, the speech comment content in which the audio file and the text are combined may expand a technique of creating and using a comment only in a form of a text, and/or may overcome technical limits of creating and using a comment in a text form and a comment in a speech form as individual contents. Once the speech comment content is created, the content creator 330 may provide the user with the speech comment content including the audio file and the text. The use may verify the speech comment content prior to registering the content. The content creator 330 may provide an environment capable of playing and recording again the audio file and/or an environment capable of, for example, correcting and/or editing the text. Accordingly, the user may verify each of the audio file and the text created as the speech comment content through the speech recording, and may perform a correction operation or a recreation operation. If the speech is to be recorded again, a text of the speech may be automatically changed. If the text is corrected without recording the speech again, an original version and a corrected version of the text may need to be separately managed with respect to the speech.

In operation S440, the content inspector 340 may perform an inspection on the speech comment content using the text of the speech comment content in response to registering the speech comment content in which the audio file and the text are combined according to a content distribution intent of the user. The content inspector 340 may determine whether to allow the distribution of the speech comment content by performing filtering on the text included in the speech comment content with respect to slangs, prohibited words, etc. If the text of the speech includes the original version and the corrected version, the content inspector 340 may inspect all of the original version and the corrected version and may determine whether to allow the distribution of corresponding content. A content distribution side may be configured to inspect contents. In the case of digital contents including speech (e.g., audios or videos), it is difficult to perform an automated inspection on the contents. Thus, an inspection may be performed in such a manner that a person directly verifies content. According to an example embodiment, the speech comment content in which speech and text are combined is created and distributed. Thus, the automated inspection may be performed on the corresponding content. Because the text of the speech is distributed together, the automated inspection may be performed on the speech comment content by applying an automated inspection technique on the text.

In operation S450, the content provider 350 may provide the inspection completed speech comment content in which the audio file and the text are combined when displaying comments created by users on a posting of a service platform. If the text included in the speech comment content includes an original version and a corrected version, the content provider 350 may provide the content in which the audio file and the corrected version of the text are combined. That is, the content provider 350 may record the speech comment content of which distribution is allowed through the inspection in a database for each service, and may provide the speech comment content to other users using the posting and creators creating comments using a comment list of each service. Here, the content provider 350 may display the text included in the speech comment content on the comment list of the posting and may provide a user interface capable of playing the audio file included in the corresponding content with the text. The content provider 350 may provide a user interface for individually playing speech with respect to each piece of speech comment content included in the comment list and may also provide a user interface for collectively playing speeches included in the entire speech comment contents included in the comment list. In addition to the speech comment content, the content provider 350 may provide a text-to-speech (TTS) function of reading a text comment included in the comment list using speech.

The content provider 350 may use the speech comment content as a portion of new content required for a service. In many cases, many digital contents that are posted are created in a form of series and content creators may need to apply user feedback or communication with users to subsequent contents. For example, in a radio broadcasting service, a radio host needs to directly read a story uploaded by a user as a text. If the radio broadcasting service uses a speech comment in which an audio file and a text are combined, it is possible to introduce a story by playing an actual speech of a user that uploads the story using a scheme of playing an audio file included in a comment.

The content provider 350 may apply various speech filters or synthesis techniques to the audio file at a point in time at which users use the speech comment content. For example, the content provider 350 may apply a baby voice, a charming voice, an angry voice, an applauding sound, a cheering sound, a voice of a specific user such as a voice actor, etc. That is, the content provider 350 may play a corresponding audio file by applying a desired (or alternatively, preset) audio file or synthesis technique at a point in time at which the audio file included in the speech comment content is played. Here, the filtering techniques and/or the synthesis techniques may be applied as a personal protection element associated with an actual speech at a play point in time of the audio file.

According to example embodiments, it is possible to create and distribute content in which an audio file and a text are combined as a comment on a posting.

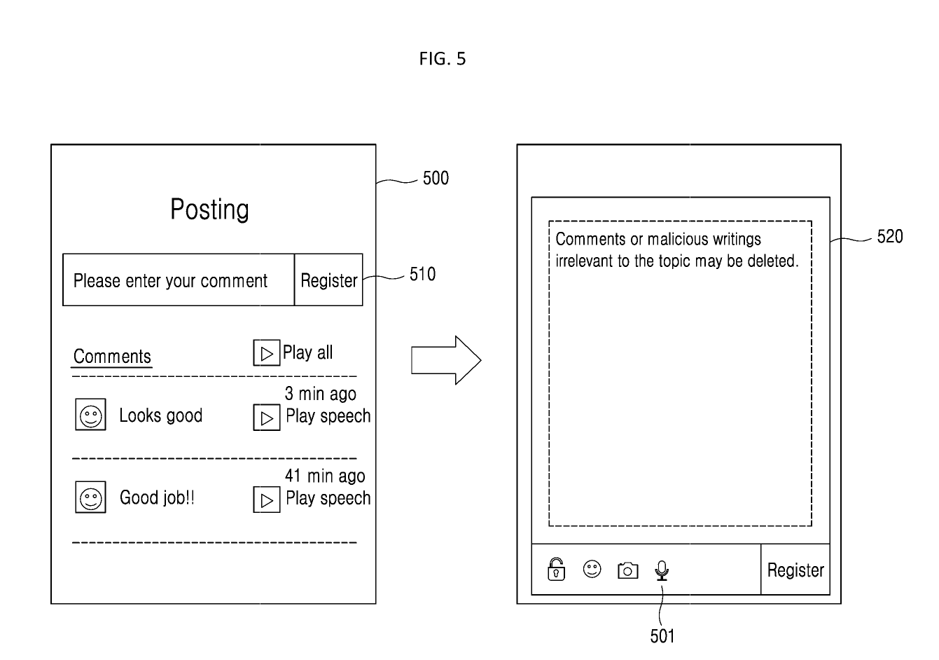

FIGS. 5 through 10 illustrate examples of a user interface screen associated with creation and distribution of speech comment content according to some example embodiments.

Referring to FIG. 5, a service screen 500 on which a posting is displayed may include a comment registration interface 510 that allows users to attach various types of comments. In response to a selection on the comment registration interface 510 on the service screen 500, a comment input screen 520 may be provided. Here, the comment input screen 520 may include a speech comment interface 501 capable of registering a comment through speech recognition.

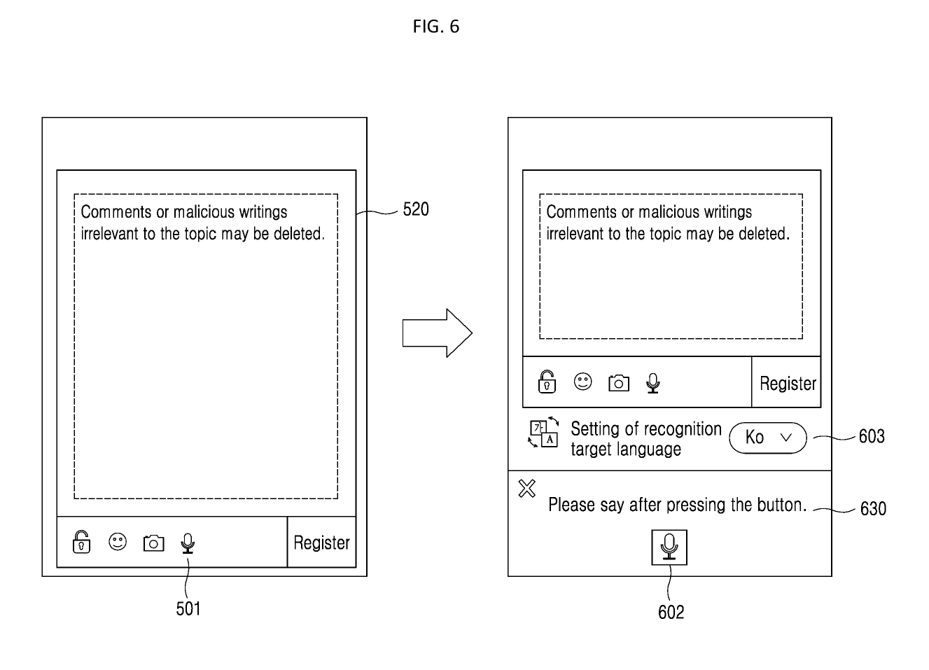

Referring to FIG. 6, in response to a selection on the speech comment interface 501 on the comment input screen 520, a recording ready screen 630 may be provided. Here, the recording ready screen 630 may include a recording interface 602 for requesting a speech recording for a user utterance.

The recording ready screen 630 may include a language setting interface 603 for setting a recognition target language. The language setting interface 603 may include a list of settable languages and currently set language information may be distinctively displayed in the list.

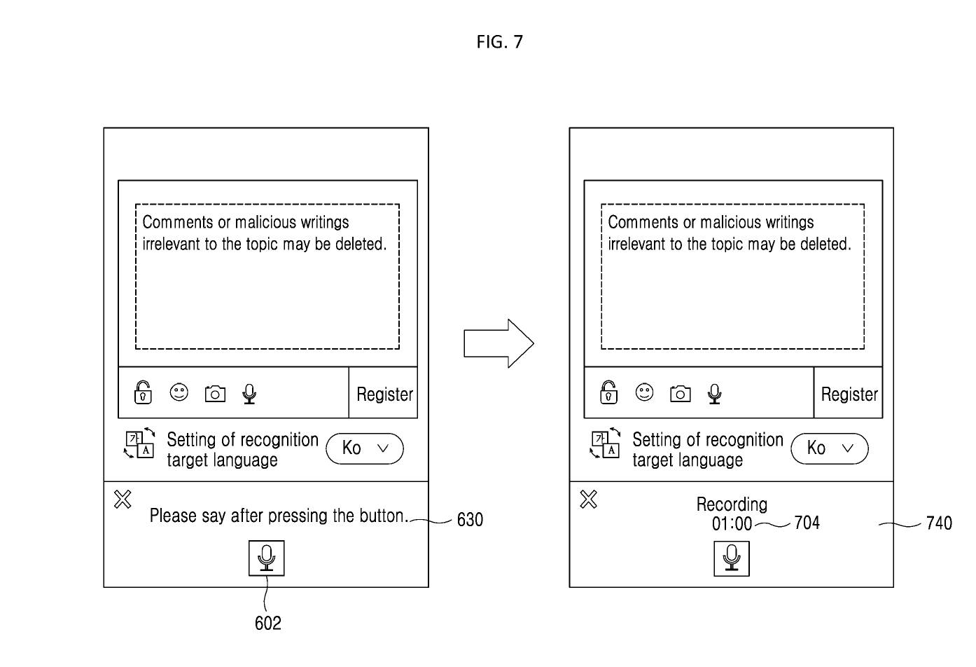

Referring to FIG. 7, in response to a selection on the recording interface 602 on the recording ready screen 630, a recording may be initiated at the same time at which a recording progress screen 740 is provided. Here, recording progress status information may be displayed on the recording progress screen 740. Further, time information 704 associated with progress of recording (e.g., a recording time limit, and/or a length of a recorded speech) may be displayed on the recording progress screen 740.

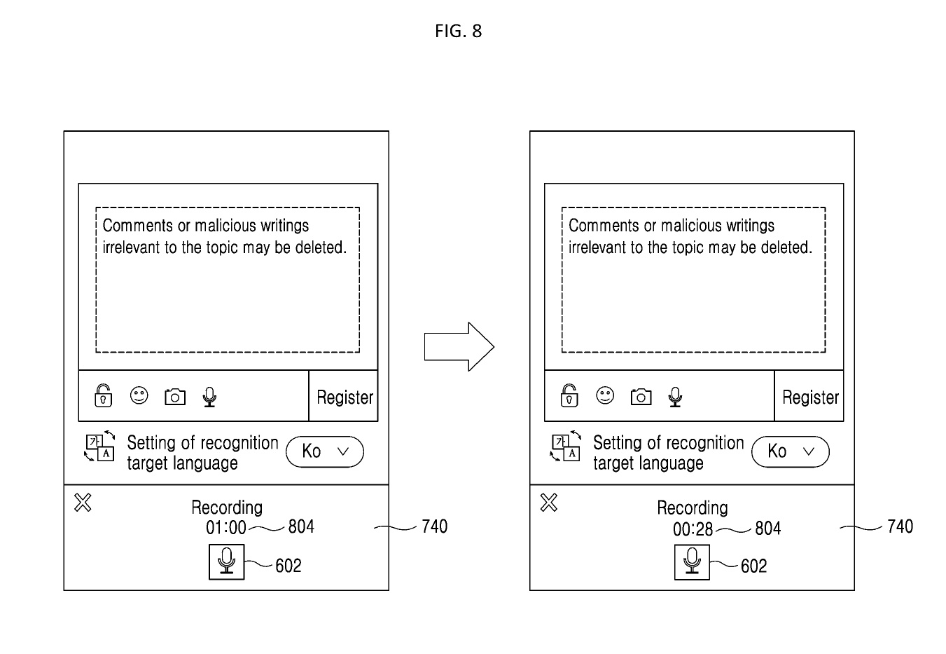

For example, referring to FIG. 8, a recording time limit may be displayed as time information 804 from a point in time at which the recording progress screen 740 is provided. For example, if the recording time limit is 1 minute, countdown from 1 minute may be displayed using the time information 804 during the progress of recording. Once the recording is initiated, the speech recording may be performed until the recording interface 602 is reselected. Although the recording interface 602 is not selected, a maximum recording time may be set as the recording time limit.

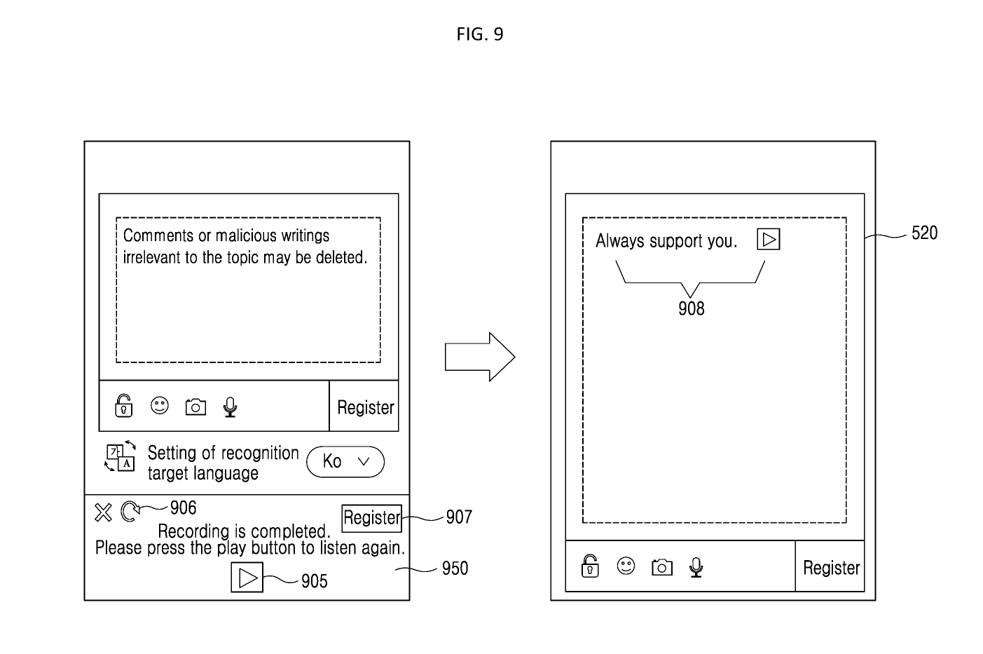

Referring to FIG. 9, once the speech recording is completed, a recording completion screen 950 may be provided. Here, the recording completion screen 950 may include, for example, a play interface 905 for playing a recorded speech, a re-recording interface 906 for initializing the speech recording and recording speech again. The recording completion screen 950 may further include a registration interface 907 for recording a recorded speech as a comment.

In response to a selection on the registration interface 907 on the recording completion screen 950, the comment input screen 520 may be provided again and speech comment content 908 created through the speech recording may be input on the comment input screen 520. The speech comment content 908 refers to content in which an audio file and a text are combined. The recorded audio file and the text extracted from the recorded speech may be automatically attached on the comment input screen 520.

Here, a text edition environment of, for example, correcting or deleting at least a portion of the attached text, inserting an additional text, and/or inserting additional content, may be provided on the comment input screen 520. The comment input screen 520 may further include an attachment removal interface (not shown) capable of deleting an attachment from the audio file included in the speech comment content 908.

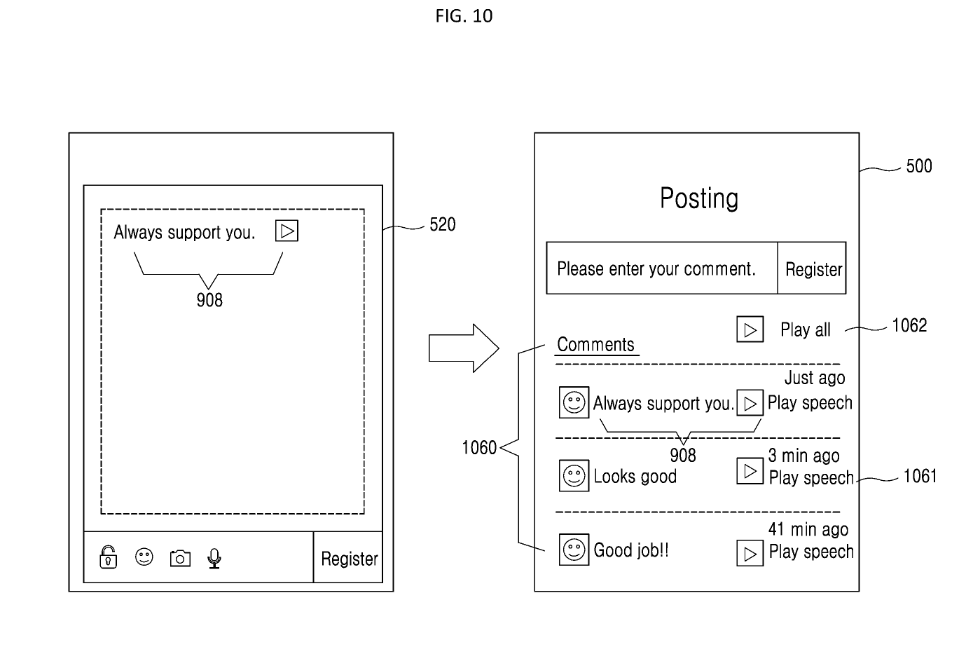

Referring to FIG. 10, in response to a selection on the comment registration interface 510 in a state in which the speech comment content 908 is attached on the comment input screen 520, the speech comment content 908 created through the speech recording of the user may be transmitted to the server 150 and transferred to an inspection system. Once the speech comment content 908 is verified as distributable content through the inspection system, the speech comment content 908 may be included in a comment list 1060 and displayed on the service screen 500.

The comment list 1060 may include a speech listen interface 1061 for individually playing an audio file included in corresponding content with respect to each piece of content included in the comment list 1060, and may further include a play-all interface 1062 for collectively playing audio files of all the contents included in the comment list 1060. In the case of content in which an audio file is absent among contents included in the comment list 1060, speech may be played through a TTS function (e.g., by reading text using speech).

According to some example embodiments, it is possible to enhance the user convenience and the utilization of speech content by creating and distributing content of a new type that is a speech comment. According to some example embodiments, it is possible to overcome limits and issues found in the art that creates and distributes content in a speech form and content in a text form as individual contents by creating and distributing a form in which speech and text are combined as a single piece of content. According to some example embodiments, it is possible to apply an automated inspection system and to perform an automated inspection by creating content in which speech and text are combined and by distributing a text corresponding to speech content. According to some example embodiments, it is possible to enhance the user convenience and to increase a speech recognition rate by selecting a recognition target language during a speech recognition providing process. According to some example embodiments, it is possible to use an actual speech of a user as new content in various forms in various types of service platforms by creating and distributing content in which speech and text are combined. According to some example embodiments, it is possible to create distinctive and entertaining content and to protect an actual speech of a user as personal information by applying various speech filters or synthesis techniques to content in a form of a speech comment.

The units and/or devices described herein may be implemented using hardware components and/or a combination of hardware components and software components. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. For example, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM, random access memory (RAM, flash memory, and the like. Examples of program instructions include both machine code, such as produced by a compiler, and files containing higher level code that may be executed by the computer using an interpreter. The described hardware devices may be to act as one or more software modules in order to perform the operations of the above-described example embodiments.

The foregoing description has been provided for purposes of illustration and description. It is not intended to be exhaustive or to limit the disclosure. Individual elements or features of a particular example embodiment are generally not limited to that particular example embodiment, but, where applicable, are interchangeable and can be used in a selected example embodiment, even if not specifically shown or described. The same may also be varied in many ways. Such variations are not to be regarded as a departure from the disclosure, and all such modifications are intended to be included within the scope of the disclosure.

What is claimed is:

1. A content providing method configured as a computer, the method comprising:
creating content in which an audio file and text extracted from speech of a user are combined, the speech being recorded as a comment on a posting; and
providing the content as a speech comment of the user.

2. The method of claim 1, further comprising:
recording the speech of the user by recording a speech signal input through speech recognition as the audio file in real time, and concurrently extracting the text from the speech signal through the speech recognition in real time.

3. The method of claim 1, wherein the creating comprises applying at least one of a speech filter or a speech synthesis technique to the audio file at a creation point in time of the content.

4. The method of claim 1, wherein the providing comprises applying at least one of a speech filter or a speech synthesis technique to the audio file at a providing point in time of the content.

5. The method of claim 1, further comprising:
recording the speech by recording a speech signal input through speech recognition as the audio file in real time,
setting a recognition target language based on language information associated with the user of the speech, and
performing the speech recognition based on the set recognition target language.

6. The method of claim 5, wherein the setting a recognition target language includes at least one of (i) automatically setting the recognition target language based on the language information included in profile information of the user or language information corresponding to a location of the user, or (ii) setting as a language selected by the user.

7. The method of claim 1, further comprising:
correcting the text before providing the content as the speech comment; and
managing an original version and a corrected version of the text in response to the correcting.

8. The method of claim 1, further comprising:
performing an automated inspection on the content using the text before providing the content as the speech comment.

9. The method of claim 1, wherein the providing comprises,
providing one or more contents as one or more speech comments in a comment list of the posting by displaying the text included in each of the one or more speech comments, the one or more contents including the content, the one or more speech comments including the speech comment, and
playing an audio file associated with the displayed text in response to an input through a user interface.

10. The method of claim 9, wherein the providing comprises at least one of,
providing a first interface for individually playing an audio file associated with a corresponding one from among the one or more speech comments included in the comment list, or
providing a second interface for collectively playing audio files associated with an entirety of the one or more speech comments included in the comment list.

11. A non-transitory computer-readable recording medium storing instructions that, when executed by a processor, cause the processor to perform a content providing method comprising:
creating content in which an audio file and text extracted from speech of a user are combined, the speech being recorded as a comment on a posting; and
providing the content as a speech comment of the user.

12. A system configured as a computer, the system comprising:
at least one processor configured to execute computer-readable instructions, the at least one processor is configured to,
create content in which an audio file and text extracted from speech of a user are combined, the speech being recorded as a comment on a posting, and
provide the content as a speech comment of the user.

13. The system of claim 12, wherein the at least one processor is further configured to,
record the speech of the user by recording a speech signal input through speech recognition as the audio file in real time, and
extract a text from the speech signal in real time through the speech recognition.

14. The system of claim 12, wherein the at least one processor is further configured to apply at least one of a speech filter or a speech synthesis technique to the audio file at a creation point in time of the content.

15. The system of claim 12, wherein the at least one processor is further configured to apply a speech filter or a speech synthesis technique to the audio file at a providing point in time of the content.

16. The system of claim 12, wherein the at least one processor is further configured to,
record the speech by recording a speech signal input through speech recognition as the audio file in real time,
set a recognition target language based on language information associated with the user of the speech, and
perform the speech recognition based on the set recognition target language.

17. The system of claim 12, wherein the at least one processor is further configured to,
correct the text before providing the content as the speech comment, and
manage an original version and a corrected version of the text in response to correcting the text.

18. The system of claim 12, wherein the at least one processor is further configured to, perform an automated inspection on the content using the text before providing the content as the speech comment.

19. The system of claim 12, wherein the at least one processor is configured to,
provide one or more contents as one or more speech comments in a comment list of the posting by displaying the text included in each of the one or more speech comments, the one or more contents including the content, the one or more speech comments including the speech comment, and
play the audio file associated with the displayed text in response to an input through a user interface.

20. The system of claim 19, wherein the at least one processor is further configured to provide at least one of (i) a first interface for individually playing an audio file associated with a corresponding one from among one or more speech comments included in the comment list or (ii) a second interface for collectively playing audio files associated with an entirety of the one or more speech comments included in the comment list.
